(19) United States
(12) Patent Application Publication
(10) Pub. No.: US 2018/0010035 A1
(43) Pub. Date: Jan. 11, 2018

(54) SECONDARY HYDROCARBON-FLUID RECOVERY ENHANCEMENT

(71) Applicant: HALLIBURTON ENERGY SERVICES, INC., Houston, TX (US)

(72) Inventors: Pubudu H. Gamage, Katy, TX (US); Cato Russell McDaniel, Montgomery, TX (US); William Walter Shumway, Spring, TX (US)

(21) Appl. No.: 15/301,731

(22) PCT Filed: Jan. 5, 2016
(86) PCT No.: PCT/US2016/012175

§ 371 Date: Oct. 4, 2016

(51) Int. Cl. C09K 8/52; C09K 8/588; C09K 8/58; E21B 43/16; E21B 43/20; E21B 49/08

(52) U.S. Cl. CPC C09K 8/52; E21B 43/20; E21B 49/08; C09K 8/58; E21B 43/16; C09K 8/588; E21B 2049/085

(57) ABSTRACT

A chelating agent can be used to enhance secondary hydrocarbon-fluid recovery during waterflooding operations. A composition can include a fluid and a chelating agent. The chelating agent can increase the viscosity of the fluid, which can enhance the efficacy of the waterflooding operations. The chelating agent can also form complexes with divalent cations in precipitates and solids formed by the divalent cations. The complexes can keep the cations in a soluble form until the composition exits the production well, which can prevent precipitates from forming in the production well and blocking pore throats in the production well.

### TECHNICAL FIELD

The present disclosure relates generally to wellbore operations. More specifically, but not by way of limitation, this disclosure relates to using a chelating agent to enhance secondary hydrocarbon-fluid recovery.

### BACKGROUND

A well system (e.g., oil or gas wells for extracting fluids from a subterranean formation) can include a production well and an injection well. During primary production operations, equipment or components can be used to recover hydrocarbon fluid (e.g., oil) from the production well. After primary production operations, secondary hydrocarbon-fluid recovery operations can be used for recovering residual hydrocarbon fluid. For example, secondary hydrocarbon-fluid recovery can include waterflooding the production wells by injecting a fluid or composition into the injection well for sweeping the residual hydrocarbon fluid toward the production well. Sweeping the residual hydrocarbon fluid can assist secondary hydrocarbon-fluid recovery from the production well.

Waterflooding the production well can cause a precipitate (e.g., a solid or insoluble material) to form in the production well. Waterflooding the production well can also cause fines (e.g., fine clay, quartz, silica, or other small particles) to migrate or move within the production well. Formation of precipitates and fines migration can reduce the efficacy of secondary hydrocarbon-fluid recovery operations. It may be desirable to enhance the efficacy of the secondary hydrocarbon-fluid recovery operations.

### BRIEF DESCRIPTION OF THE DRAWINGS

FIG. 1 is a schematic diagram of a well system that includes a production well and an injection well, according to one example of the present disclosure.

FIG. 2 is a block diagram of an example of a well analyzer, according to one example of the present disclosure.

FIG. 3 is a flow chart depicting an example of a process for determining a chelating agent that can be included in a composition for waterflooding a production well, according to one example of the present disclosure.

FIG. 4 is a graph depicting an example of effects of a solution, which includes a chelating agent that is ethylenediamine tetraacetic acid (“EDTA”), on phosphorous release from dentin over a period of time.

### DETAILED DESCRIPTION

Certain aspects and features of the present disclosure are directed to using a chelating agent to enhance secondary hydrocarbon-fluid recovery operations. A chelating agent can be a chemical used to bind metal ions to form a ring structure. In some examples, the chelating agent can prevent a precipitate from forming. Enhancing secondary hydrocarbon-fluid recovery can include improving the permeability of the production well (e.g., the ability of the production well to transmit fluids) or preventing damage to a formation of the production well.

A composition injected into an injection well during secondary hydrocarbon-fluid recovery operations can include a fluid and a chelating agent. In some examples, the chelating agent can increase the viscosity of the fluid, which can enhance secondary hydrocarbon-fluid recovery. For example, increasing the viscosity of the fluid can enhance the ability of the fluid to sweep hydrocarbon fluid toward a production well. In some examples, the chelating agent can dissolve a precipitate in the production well. The chelating agent may also keep ions in the production well in a soluble form until the composition exits the production well. Keeping ions in the production well in a soluble form can prevent precipitates from forming in the production well to prevent the precipitates from blocking pore throats in the production well, which can improve the ability of the production well to transmit hydrocarbon fluids. In some examples, the chelating agent can solubilize or dissolve fines produced in the formation in the production well. Solubilizing fines can reduce fines migration, which may prevent formation damage.

In some examples, a type of fluid or chelating agent to be included in a composition for waterflooding a production well can be determined based on a property of the production well. In another example, the fluid to be included in the composition can be determined based on a compatibility analysis (e.g., a test to determine a compatibility of the type of fluid with a property of the production well).

In some examples, a composition for waterflooding a production well can include a polymer or other chemical, along with the fluid and chelating agent. For example an organic silica dissolver (e.g., catechol or tropolone) can be included in the composition to sweep hydrocarbon fluid toward a production well that has a high silicate or fine content (e.g., high clay content). In another example, a polymer can be included in the composition to increase the viscosity of the fluid in the composition.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

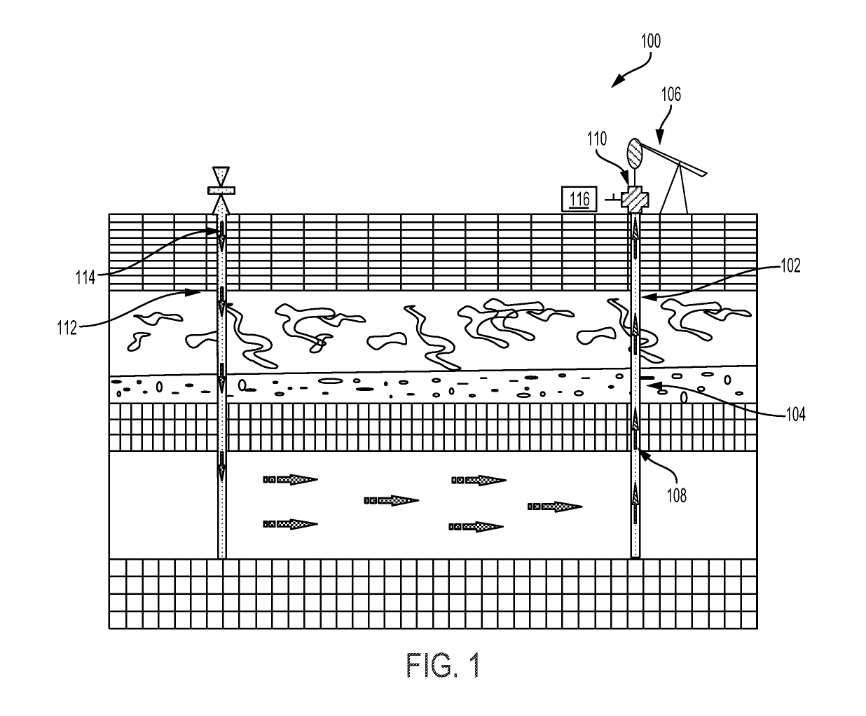

FIG. 1 is a schematic diagram of a well system 100 that includes a production well 102 and an injection well 112. The production well 102 can be an oil, water, or gas well for extracting fluids from a hydrocarbon bearing formation 104. A pump 106 (e.g., a beam pump or a pump jack) can be used to produce hydrocarbon fluid 108 (e.g., gas or oil) from the production well 102.

The injection well 112 can be a well that is associated with, or positioned proximate to, the production well 102. A composition 114 can be injected into the injection well 112 for waterflooding the production well 102. In some examples, the composition 114 may sweep hydrocarbon fluid 108 toward the production well 102 as the composition 114 flows from the injection well 112 toward the production well 102.

The composition 114 can include a fluid. Examples of the fluid include, but are not limited to, produced water, sea water, or brine. Produced water can be water that is produced from a wellbore and is not a treatment fluid. Sea water can be water from an ocean or water that contains low salinity and has a high hardness. Brine can be a solution of salt in water or water containing more dissolved inorganic salt than seawater.

The composition 114 can also include a chelating agent. Examples of the chelating agent include, but are not limited to, ethylenediamine tetraacetic acid (“EDTA”), gluconate, ammonium gluconate, diammonium ethylenediaminetetraacetate hydroxyethylenediamine triacetic acid (“HEDTA”), nitriolotriacetic acid (“NTA”), citric acid, sugar acid (e.g., gluconic acid), fructose, catechol, etc.

In some examples, the chelating agent in the composition 114 can dissolve a precipitate as the composition 114 flows toward the production well 102. For example, the precipitate can form from a chemical reaction of two or more ions. As an example, divalent cations can react with ions in the production well 102 and cause the precipitate to form. The chelating agent can form a complex with divalent cations in the precipitate by covalent bonds. The complex can be a molecule that includes a central atom or ion (e.g., a metallic atom or ion) and a surrounding array of ligands or complexing agents (e.g., an array of bound molecules or ions). In some examples, the complex can dissolve the precipitate. The chelating agent may also keep ions in the production well 102 in a soluble form. In another example, the chelating agent can solubilize fines that are produced or moving in the formation 104.

Using the chelating agent to dissolve a precipitate in the production well 102 can prevent the precipitate from blocking a pore throat of the formation 104, which may increase the ability of the production well 102 to transmit hydrocarbon fluid 108. In another example, using the chelating agent to solubilize fines in the production well 102 can reduce damage to the formation 104.

In some examples, a type of chelating agent or fluid to be included in the composition 114 can be determined or selected based on various factors. For example, the type of chelating agent or fluid can be selected based on a property of the production well 102. Examples of a property of the production well 102 include, but are not limited to, a temperature of the formation 104, brine composition of the formation 104, lithology of the formation 104 (e.g., macroscopic nature of mineral content, grain size, or texture of the formation 104), a pH (e.g., acidity or alkalinity) of the production well 102, an ion content or concentration of the production well 102 (e.g., an amount of an ion in the production well 102), or properties of a hydrocarbon in the production well (e.g., properties of the hydrocarbon fluid 108).

In some examples, a well analyzer 116 can be used to determine a property of the production well 102. The well analyzer 116 can be a device for analyzing fluid or an extract from the production well 102. The well analyzer 116 can be positioned proximate to the production well 102. In another example, the well analyzer 116 can be positioned elsewhere in the well system 100 (e.g., in the production well 102) or at a remote location (e.g., an offsite laboratory). In some examples, a type of chelating agent or fluid that can be included in the composition 114 can be determined based on the property of the production well 102 determined using the well analyzer 116.

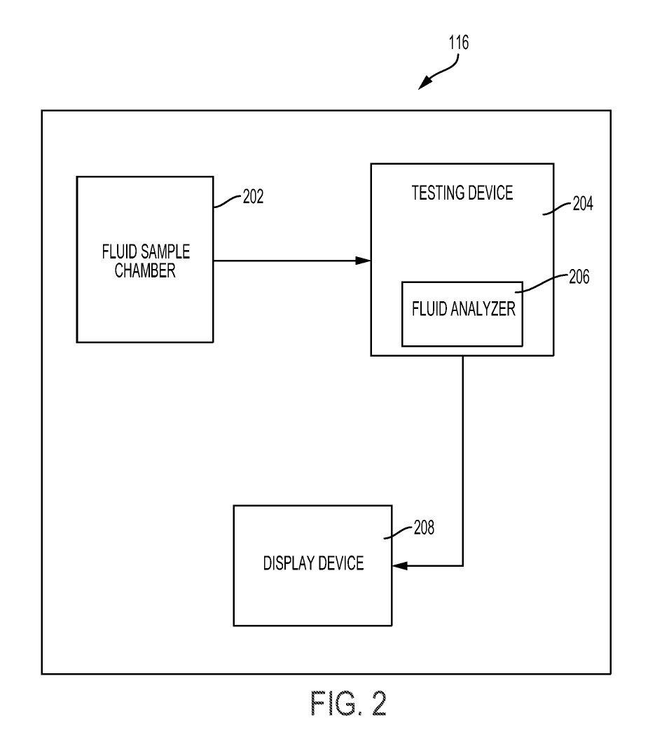

FIG. 2 is a block diagram of an example of a well analyzer 116, according to one example of the present disclosure. In the example depicted in FIG. 2, the well analyzer 116 can include a fluid sample chamber 202, a testing device 204, a fluid analyzer 206, and input/output interface components (e.g., a display device 208). The well analyzer 116 can also include other input/output interface components such as a keyboard, touch-sensitive surface, and additional storage.

In some examples, a fluid sample can be collected from a production well (e.g., the production well 102) including without limitation, through manual collection (e.g., manual labor) or through automated collection (e.g., by the well analyzer 116 or another apparatus, device, machine, or the like). The well analyzer 116 can receive the fluid sample from the production well. For example, the well analyzer 116 can receive the fluid sample via the fluid sample chamber 202. The testing device 204 can be coupled to the fluid sample chamber 202 for receiving the fluid sample from the fluid sample chamber 202. The testing device 204 can be any device for testing or analyzing a fluid sample. In some examples, the well analyzer 116 can use the testing device 204 to analyze the fluid sample (e.g., conduct a test or a series of tests using the fluid sample) for determining a property of the production well. For example, the testing device 204 can be used to conduct a pH test on the fluid sample. A result of the pH test may indicate a pH of the fluid sample. The pH of the fluid sample may indicate that the production well has an acidic or basic property. As another example, a result of analyzing the fluid sample using the testing device 204 can indicate an ion content of the fluid sample, which may correspond to a sulfate-ion content or a bicarbonate ion content of the production well. In still another example, a result of analyzing the fluid sample using the testing device 204 can indicate an a property of a hydrocarbon in the fluid sample, which may represent a property of a hydrocarbon fluid in the production well (e.g., the hydrocarbon fluid 108 in FIG. 1).

The fluid analyzer 206 can be used to conduct a fluid compatibility analysis for determining a type of fluid that can be included in a composition for the production well. The fluid compatibility analysis can include any test, or series of tests, that may be performed using the fluid analyzer 206 for determining whether the type of fluid can be compatible with the production well. The fluid compatibility analysis can include determining compatibility of the type of fluid with a property of the production well 102 (e.g., a property determined using the testing device 204). In some examples, a result of the fluid compatibility analysis may indicate that a precipitate may form in the production well if a type of fluid is included in a composition for the production well. To avoid forming a precipitate in the production well, the type of fluid to be included in the composition can be selected based on a result of the fluid compatibility analysis.

The testing device 204 can be communicatively coupled to the display device 208. The display device 208 can receive data from the testing device 204 and display data received. The data can correspond to a result of an analysis conducted using the testing device 204. For example, the data can correspond to a result of a pH test conducted on a fluid sample from the production well using the testing device 204. As another example, the data can correspond to a result of a fluid compatibility analysis conducted using the fluid analyzer 206. In some examples, data displayed by the display device 208 can be used to determine a property of the production well and a type of fluid or chelating agent that can be included in a composition for the production well.

In some examples, the components of the well analyzer 116 shown in FIG. 2 can be integrated into a single structure. For example, the components can be within a single housing or chassis. In other examples, the components shown in FIG. 2 can be distributed (e.g., in separate housings) and in electrical communication with each other.

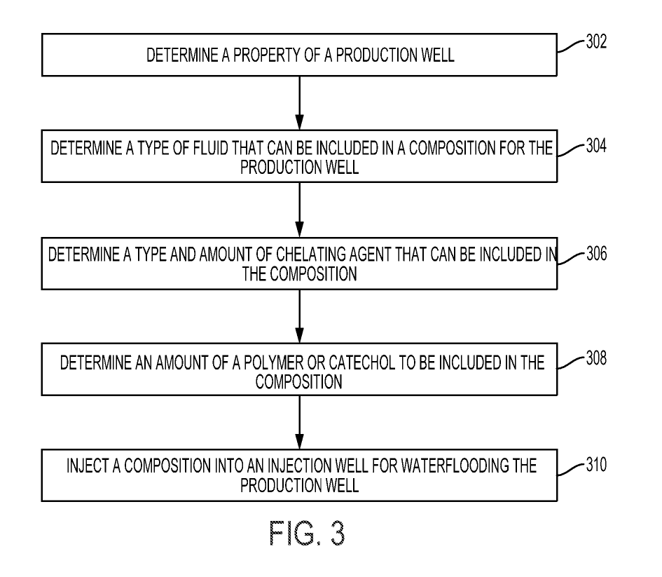

FIG. 3 is a flow chart depicting an example of a process for determining a chelating agent or a fluid that can be included in a composition for waterflooding a production well.

In block 302, a property of a production well is determined. In some examples, a well analyzer (e.g., the well analyzer 116 of FIG. 1) can be used to determine a property of the production well. Examples of a property of the production well include, but are not limited to, a temperature of a formation of the production well, a brine composition of the formation, a lithology of the formation, an ion content or concentration of the production well, a pH of the production well, or properties of a hydrocarbon in the production well. For example, the well analyzer can be used to analyze fluid from the production well to determine the property of the production well. As an example, the well analyzer can be used to analyze the fluid to determine a pH of the fluid, which may represent the pH of the production well.

In some examples, a property of the production well may indicate a type of the production well. For example, the property of the production may indicate that the production well is a sandstone production well or a carbonate production well.

In block 304, a type of fluid that can be included in a composition for the production well is determined. In some examples, the type of fluid can be determined based on a property of the production well (e.g., a property of the production well determined in block 302) or a compatibility of the type of fluid with the property of the production well. For example, a fluid analyzer (e.g., the fluid analyzer 206 of FIG. 2) can be used to conduct a fluid compatibility analysis to determine whether a type of fluid can be compatible with the production well. In some examples, a result of the fluid compatibility analysis may indicate that the type of fluid is not compatible with the production well because an undesirable reaction may occur if the type of fluid is included in a composition for the production well. An example of the undesirable reaction can include precipitation or scaling in the production well.

As an example, a property of a production well (e.g., a property determined in block 302) may indicate that the production well has a high sulfate-ion content. The fluid analyzer can be used to determine whether a fluid that includes hydrochloric acid can be compatible with the production well. A result of the fluid compatibility analysis may indicate that injecting fluid that includes hydrochloric acid into the production well can generate a high concentration of calcium ions, which may precipitate calcium sulfate when the hydrochloric acid interacts with water in the formation of the production well. The result of the fluid compatibility analysis can be used to determine a type of fluid that can be include in the composition to avoid forming precipitates in the production well.

In block 306, a type and amount of a chelating agent that can be included in the composition is determined. In some examples, the type and amount of the chelating agent that can be included in the composition can be selected or determined based on a property of the production well (e.g., a property of the production well determined in block 302). As an example, a high pH tolerant chelating agent (e.g., sugar acid, fructose, or ammonium gluconate) may be included in the composition if the production well has a high pH or if a pH increase may occur when the fluid is injected (e.g., if a pH increase in the production well has been observed during prior low salinity waterflooding). An example of the sugar acid can include gluconic acid.

In block 308, an amount of a polymer or catechol to be included in the composition is determined. In some examples, the amount of catechol to be included in the composition can be determined based on a property of the production well (e.g., a property of the production well determined in block 302). As an example, a property of the production well may indicate that the production well has a high silicate content or high fine content. Catechol may be included in the composition to solubilize silicates that may be produced from fines in a formation of the production well. In some examples, the amount of catechol can be up to a solubility limit of catechol in the composition. In another example, another organic silica dissolver (e.g., tropolone) can be added to the composition to solubilize silicates produced from fines in the formation of the production well.

In some examples, in block 308, a polymer can also be included in composition. The polymer can be included in the composition to increase the viscosity of a fluid in the composition (e.g., the fluid selected in block 304).

In block 310 a composition is injected into an injection well for waterflooding the production well. The composition can include a fluid (e.g., the fluid selected in block 304) and a chelating agent (e.g., the chelating agent selected in block 306). In some examples, the composition can also include catechol, tropolone, or another silica dissolver. In another example, the composition can also include a polymer.

In some examples, the injection well can be associated with the production well (e.g., positioned proximate to the production well). Waterflooding the production well can include injecting the composition into the injection well to displace or sweep hydrocarbon fluid (e.g., oil) toward the production well. In some examples, the chelating agent can enhance the ability of the composition to sweep hydrocarbon fluid toward the production well by increasing the viscosity of the fluid. In some examples, the chelating agent may prevent scaling in the production well. In another example, the chelating agent can dissolve a precipitate or solubilize fines in the formation of the production well.

In some examples, different types of chelating agents can be included in the composition for the production well. Including different types of chelating agents in the composition may allow the chelating agents to dissolve various types of precipitates or fines in the production well. For example, one type of chelating agent in the composition may dissolve a type of precipitate or solubilize a type of fine. Another type of chelating agent in the composition may dissolve another type of precipitate or solubilize another type of fine.

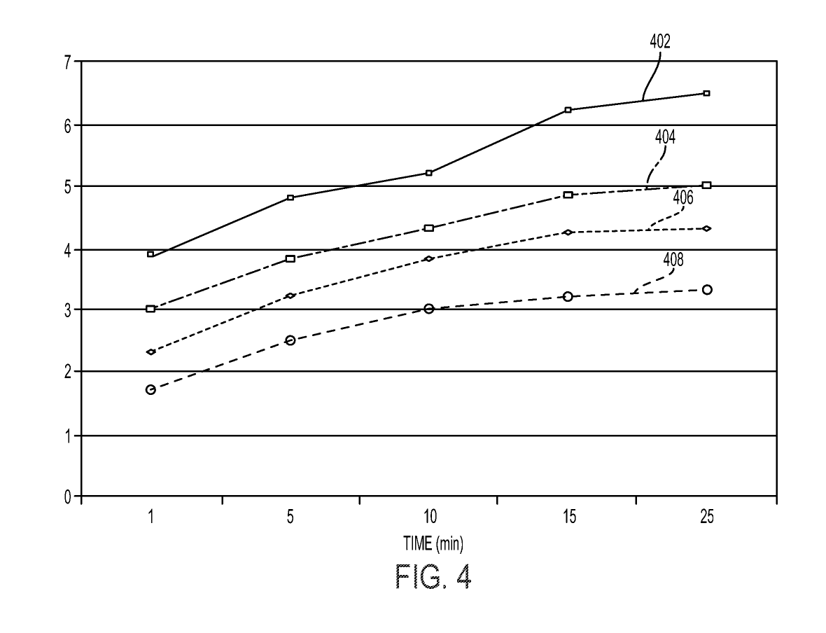

FIG. 4 is a graph depicting an example of effects of a solution, which includes a chelating agent that is EDTA, on phosphorous release from dentin over a period of time.

In the example depicted in FIG. 4, line 402 shows the effect of a solution that includes ten percent EDTA at a pH of 7.5 on phosphorous release from dentin over twenty-five minutes of exposure. Line 404 shows the effect of a solution that includes ten percent EDTA at a pH of 9 on phosphorous release from dentin over twenty-five minutes of exposure. Line 406 shows the effect of a solution that includes seventeen percent EDTA at a pH of 7.5 on phosphorous release from dentin over twenty-five minutes of exposure. Line 408 shows the effect of a solution that includes seventeen percent EDTA at a pH of 9 on phosphorous release from dentin over twenty-five minutes of exposure.

In some aspects, compositions and methods for enhancing secondary hydrocarbon-fluid recovery operations using a chelating agent are provided according to one or more of the following examples:

Example #1: A composition can include a fluid and a chelating agent. The chelating agent can be selected based on a property of a production wellbore through a subterranean formation. The composition can be injectable into an injection wellbore associated with the production wellbore for reducing precipitate formation in sweeping production fluid toward the production wellbore.

Example #2: The composition of Example #1 may feature the chelating agent including at least one of ethylenediamine tetraacetic acid, gluconate, ammonium gluconate, diammonium ethylenediam inetetraacetate hydroxyethylenediamine triacetic acid, nitriolotriacetic acid, citric acid, sugar acid, fructose, or mixtures thereof.

Example #3: The composition of any of Examples #1-2 may feature the fluid including at least one of sea water, produced water, or brine.

Example #4: The composition of any of Examples #1-3 may feature catechol or tropolone for dissolving a silicate precipitate in the subterranean formation.

Example #5: The composition of any of Examples #1-4 may feature a polymer for increasing a viscosity of the fluid.

Example #6: The composition of any of Examples #1-5 may feature the property of the production wellbore including a temperature of the subterranean formation, a lithology of the subterranean formation, a brine composition of the subterranean formation, a pH of the production wellbore, an ion content of the production wellbore, or a hydrocarbon property of the production wellbore.

Example #7: A method can include determining a property of a production wellbore through a subterranean formation. The method can also include determining a fluid for the production wellbore based on the property of the production wellbore. The method can further include determining a chelating agent for the production wellbore based on the property of the production wellbore. The method can also include injecting a composition that includes the fluid and the chelating agent into an injection wellbore associated with the production wellbore for reducing precipitate formation in sweeping production fluid toward the production wellbore.

Example #8: The method of Example #7 may feature determining the property of the production wellbore including analyzing, using a well analyzer, a sample of fluid from the production wellbore and determining the property of the production wellbore based on a result of analyzing the sample of fluid.

Example #9: The method of any of Examples #7-8 may feature the chelating agent including ethylenediamine tetraacetic acid, gluconate, ammonium gluconate, diammonium ethylenediaminetetraacetate hydroxyethylenediamine triacetic acid, nitriolotriacetic acid, citric acid, sugar acid, fructose, or mixtures thereof.

Example #10: The method of any of Examples #7-9 may feature determining the chelating agent for the production wellbore based on the property of the production wellbore including determining a pH level of the production wellbore and selecting the chelating agent based on the pH level of the production wellbore.

Example #11: The method of any of Examples #7-10 may feature determining the fluid for the production wellbore including conducting, using a fluid analyzer, a fluid compatibility analysis on the fluid and determining a compatibility of the fluid with the production wellbore based on a result of the fluid compatibility analysis.

Example #12: The method of any of Examples #7-11 may feature the composition further including an organic silica dissolver for dissolving silicate precipitate in the subterranean formation. The organic silica dissolver can include tropolone or catechol.

Example #13: The method of any of Examples #7-12 may feature the composition further including a polymer for increasing a viscosity of the fluid.

Example #14: The method of any of Examples #7-13 may feature the fluid including at least one of sea water, produced water, or brine.

Example #15: A composition can include a fluid, catechol or tropolone, and a chelating agent. The chelating agent or the fluid can be selected based on a first property of a production wellbore through a subterranean formation. The catechol can be selected based on a second property of the production wellbore. The composition can be injectable into an injection wellbore associated with the production wellbore for reducing precipitate formation and dissolving at least some precipitates in sweeping production fluid toward the production wellbore.

Example #16: The composition of Example #15 may feature a polymer for increasing a viscosity of the fluid.

Example #17: The composition of any of Examples #15-16 may feature the chelating agent including at least one of ethylenediamine tetraacetic acid, gluconate, ammonium gluconate, diammonium ethylenediaminetetraacetate hydroxyethylenediamine triacetic acid, nitriolotriacetic acid, citric acid, sugar acid, fructose, or mixtures thereof.

Example #18: The composition of any of Examples #15-17 may feature the first property of the production wellbore and the second property of the production wellbore being determined based on a result of an analysis on a sample of fluid from the production wellbore.

Example #19: The composition of any of Examples #15-18 may feature the first property of the production wellbore including a hydrocarbon property of the production wellbore and an ion content of the production wellbore, and the second property of the production wellbore including a silicate content in the subterranean formation.

Example #20: The composition of any of Examples #15-19 may feature the fluid including at least one of sea water, produced water, or brine.

Example #21: A composition can include a fluid, catechol or tropolone, and a chelating agent. The chelating agent can include at least one of ethylenediamine tetraacetic acid, gluconate, ammonium gluconate, diammonium ethylenediaminetetraacetate hydroxyethylenediamine triacetic acid, nitriolotriacetic acid, citric acid, sugar acid, fructose, or mixtures thereof.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A composition comprising:
a fluid; and
a chelating agent selected based on a property of a production wellbore through a subterranean formation, wherein the composition is injectable into an injection wellbore associated with the production wellbore for reducing precipitate formation in sweeping production fluid toward the production wellbore.

2. The composition of claim 1, wherein the chelating agent comprises at least one of ethylenediamine tetraacetic acid, gluconate, ammonium gluconate, diammonium ethylenediaminetetraacetate hydroxyethylenediamine triacetic acid, nitriolotriacetic acid, citric acid, sugar acid, fructose, or mixtures thereof.

3. The composition of claim 1, wherein the fluid comprises at least one of sea water, produced water, or brine.

4. The composition of claim 1, further comprising catechol or tropolone for dissolving a silicate precipitate in the subterranean formation.

5. The composition of claim 1, further comprising a polymer for increasing a viscosity of the fluid.

6. The composition of claim 1, wherein the property of the production wellbore includes a temperature of the subterranean formation, a lithology of the subterranean formation, a brine composition of the subterranean formation, a pH of the production wellbore, an ion content of the production wellbore, or a hydrocarbon property of the production wellbore. A method comprising:
determining a property of a production wellbore through a subterranean formation;
determining a fluid for the production wellbore based on the property of the production wellbore;
determining a chelating agent for the production wellbore based on the property of the production wellbore; and
injecting a composition that includes the fluid and the chelating agent into an injection wellbore associated with the production wellbore for reducing precipitate formation in sweeping production fluid toward the production wellbore.

8. The method of claim 7, wherein determining the property of the production wellbore includes:
analyzing, using a well analyzer, a sample of fluid from the production wellbore; and
determining the property of the production wellbore based on a result of analyzing the sample of fluid.

9. The method of claim 7, wherein the chelating agent includes ethylenediamine tetraacetic acid, gluconate, ammonium gluconate, diammonium ethylenediaminetetraacetate hydroxyethylenediamine triacetic acid, nitriolotriacetic acid, citric acid, sugar acid, fructose, or mixtures thereof.

10. The method of claim 7, wherein determining the chelating agent for the production wellbore based on the property of the production wellbore includes:
determining a pH level of the production wellbore; and
selecting the chelating agent based on the pH level of the production wellbore.

11. The method of claim 7, wherein determining the fluid for the production wellbore includes:
conducting, using a fluid analyzer, a fluid compatibility analysis on the fluid; and
determining a compatibility of the fluid with the production wellbore based on a result of the fluid compatibility analysis.

12. The method of claim 7, wherein the composition further includes an organic silica dissolver for dissolving silicate precipitate in the subterranean formation, the organic silica dissolver including tropolone or catechol.

13. The method of claim 7, wherein the composition further includes a polymer for increasing a viscosity of the fluid.

14. The method of claim 7, wherein the fluid comprises at least one of sea water, produced water, or brine.

15. A composition comprising:
a fluid;
catechol or tropolone; and
a chelating agent,
wherein the chelating agent or the fluid is selected based on a first property of a production wellbore through a subterranean formation and the catechol is selected based on a second property of the production wellbore and wherein the composition is injectable into an injection wellbore associated with the production wellbore for reducing precipitate formation and dissolving at least some precipitates in sweeping production fluid toward the production wellbore.

16. The composition of claim 15, further comprising a polymer for increasing a viscosity of the fluid.

17. The composition of claim 15, wherein the chelating agent includes at least one of ethylenediamine tetraacetic acid, gluconate, ammonium gluconate, diammonium ethylenediaminetetraacetate hydroxyethylenediamine triacetic acid, nitriolotriacetic acid, citric acid, sugar acid, fructose, or mixtures thereof.

18. The composition of claim 15, wherein the first property of the production wellbore and the second property of the production wellbore are determined based on a result of an analysis on a sample of fluid from the production wellbore.

19. The composition of claim 15, wherein the first property of the production wellbore includes a hydrocarbon property of the production wellbore and an ion content of the production wellbore, and the second property of the production wellbore includes a silicate content in the subterranean formation.

20. The composition of claim 15, wherein the fluid comprises at least one of sea water, produced water, or brine.

21. A composition comprising:
a fluid;
catechol or tropolone; and
a chelating agent including at least one of ethylenediamine tetraacetic acid, gluconate, ammonium gluconate, diammonium ethylenediaminetetraacetate hydroxyethylenediamine triacetic acid, nitriolotriacetic acid, citric acid, sugar acid, fructose, or mixtures thereof.
